(19) United States
(12) Patent Application Publication
(10) Pub. No.: US 2021/0389502 A1
(43) Pub. Date: Dec. 16, 2021

(54) INFORMATION PROCESSING APPARATUS, INFORMATION PROCESSING SYSTEM, INFORMATION PROCESSING METHOD, AND NON-TRANSITORY COMPUTER READABLE MEDIUM STORING PROGRAM

(71) Applicants: NEC CORPORATION, Tokyo (JP); NATIONAL INSTITUTE OF ADVANCED INDUSTRIAL SCIENCE AND TECHNOLOGY, Tokyo (JP)

(72) Inventors: Keiichi KISAMORI, Tokyo (JP); Keisuke YAMAZAKI, Tokyo (JP)

(73) Assignees: NEC CORPORATION, Tokyo (JP); NATIONAL INSTITUTE OF ADVANCED INDUSTRIAL SCIENCE AND TECHNOLOGY, Tokyo (JP)

(21) Appl. No.: 17/282,707

(22) PCT Filed: Oct. 2, 2019
(86) PCT No.: PCT/JP2019/038940

§ 371 Date: Apr. 2, 2021

(30) Foreign Application Priority Data
Oct. 3, 2018 (JP) 2018188190

(51) Int. Cl. G01W 1/10; G05B 13/04; G05B 17/02

(52) U.S. Cl. CPC G01W 1/10; G05B 17/02; G05B 13/048

(57) ABSTRACT

Parameters are efficiently calculated. An information processing apparatus (1) includes a corresponding data calculation unit (2) configured to determine importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information, and calculate data that corresponds to distribution of the parameters; and a new parameter sample generation unit (3) configured to generate a new sample of the parameters in accordance with predetermined processing using data that corresponds to distribution of the parameters.

### TECHNICAL FIELD

The present disclosure relates to an information processing apparatus, an information processing method, and a program.

### BACKGROUND ART

Several techniques related to numerical prediction using a prediction model and learning of this prediction model have been proposed.

For example, Patent Literature 1 discloses a weather prediction system for regularly performing weather prediction using a weather prediction model. This weather prediction system performs weather prediction by assimilating observation data in a weather prediction model and changes an operation parameter to be used for an operation of weather prediction in accordance with a predicted time.

Further, a prediction apparatus disclosed in Patent Literature 2 generates a plurality of prediction models and generates, for each of the prediction models, a residual prediction model that predicts a residual difference. This prediction apparatus then combines, for a predicted value for each prediction model, a residual predicted value by a residual prediction model, and calculates a predicted value as a prediction apparatus.

### CITATION LIST

### Patent Literature

[Patent Literature 1] Japanese Unexamined Patent Application Publication No. 2008-008772

[Patent Literature 2] Japanese Unexamined Patent Application Publication No. 2005-135287

### SUMMARY OF INVENTION

### Technical Problem

However, even when the system disclosed in Patent Literature 1 and the apparatus disclosed in Patent Literature 2 are used, it is not possible to efficiently execute a highly-accurate prediction. The reason for this is that it is impossible to efficiently determine parameters in a prediction model.

With regard to the above circumstances, one of the objects that example embodiments herein disclosed will attain is to provide an information processing apparatus and the like capable of efficiently calculating parameters.

### Solution to Problem

An information processing apparatus according to a first aspect includes:

corresponding data calculation means for determining importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information, and calculating data that corresponds to distribution of the parameters; and

new parameter sample generation means for generating a new sample of the parameters in accordance with predetermined processing using the data that corresponds to distribution of the parameters.

An information processing method according to a second aspect includes:

determining, by an information processing apparatus, importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information and calculating data that corresponds to distribution of the parameters; and

generating, by the information processing apparatus, a new sample of the parameters in accordance with predetermined processing using the data that corresponds to distribution of the parameters.

A program according to a third aspect causes a computer to execute:

a corresponding data calculation step for determining importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information and calculating data that corresponds to distribution of the parameters; and

a new parameter sample generation step for generating a new sample of the parameters in accordance with predetermined processing using the data that corresponds to distribution of the parameters.

### Advantageous Effects of Invention

According to the above aspects, it is possible to provide an information processing apparatus and the like capable of efficiently calculating parameters.

### BRIEF DESCRIPTION OF DRAWINGS

FIG. 1 is a block diagram showing one example of a configuration of an information processing system according to an example embodiment;

FIG. 2 is a block diagram showing one example of a hardware configuration of an information criterion calculation apparatus according to the example embodiment;

FIG. 3 is a block diagram showing one example of a functional configuration of an information criterion calculation apparatus according to a first example embodiment;

FIG. 4 is a flowchart showing one example of an operation of the information criterion calculation apparatus according to the first example embodiment;

FIG. 5 is a block diagram showing one example of a functional configuration of an information criterion calculation apparatus according to a second example embodiment;

FIG. 6 is a flowchart showing one example of an operation of the information criterion calculation apparatus according to the second example embodiment; and

FIG. 7 is a block diagram showing one example of a functional configuration of an information processing apparatus according to other example embodiments.

### DESCRIPTION OF EMBODIMENTS

While the present disclosure will be described using mathematical terms in order to facilitate understanding in each of the following example embodiments, each of these terms may not be necessarily defined mathematically. For example, a distance can be mathematically defined, like a Euclidean norm or one norm. The distance may instead be a value obtained by adding one to the above value. That is, terms that are used in the following example embodiments may not be terms that are mathematically defined.

### First Example Embodiment

Hereinafter, with reference to the drawings, embodiments of the present disclosure will be described.

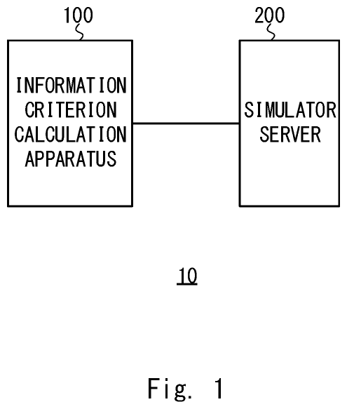

FIG. 1 is a block diagram showing one example of a configuration of an information processing system 10 according to an example embodiment. As shown in FIG. 1, the information processing system 10 includes an information criterion calculation apparatus 100 and a simulator server (simulator) 200. Note that the information criterion calculation apparatus 100 may be referred to as an information processing apparatus.

The simulator server 200 is a simulator that receives an input of data of a first type and outputs data of a second type. That is, the simulator server 200 performs simulation processing of predicting the data of the second type from the data of the first type in accordance with a model defined by a parameter θ. The simulator server 200 executes, for example, processing of simulating processing (operation) in an observation target based on the sample of the parameter θ. The sample expresses the value of the parameter θ. Therefore, a plurality of samples express a plurality of examples (a plurality of pieces of data) set as the value of the parameter θ.

In the following description, the data of the first type is referred to as data X and the data of the second type is referred to as data Y. Further, observation data of the data X (observation data of the first type) is denoted by observation data Xⁿ and observation data of the data Y (observation data of the second type) is denoted by observation data Yⁿ, where n (n is a positive integer) denotes the number of pieces of observation data. Further, elements of the observation data Xⁿ are expressed by X₁, . . . , Xₙ and elements of the observation data Yⁿ are expressed by Y₁, . . . , Yₙ. The information criterion calculation apparatus 100 acquires observation data (therefore, observation data that can be plot on the X-Y plane) in which the data Xᵢ (i is an integer within 1≤i≤n) is associated one to one with the data Yᵢ.

In the following description, the observation data may be referred to as observation information. Further, the observation data Yⁿ may be referred to as a plurality of pieces of observation information. In this case, each of the elements Y₁, . . . , Yₙ may be indicated as observation information.

The observation data Xⁿ and Yⁿ are not limited to data of particular types and may be various kinds of data that have been actually measured. The measurement method to obtain the observation data is not limited to a specific method and various methods such as counting or measuring by a person like a user, sensing using a sensor or the like may be employed.

The elements of the observation data Xⁿ may indicate the state of components that compose the observation target. The elements of the observation data Yⁿ may indicate the state observed regarding the observation target using a sensor or the like. When, for example, the user desires to analyze the productivity of a manufacturing factory, the observation data Xⁿ may indicate the operation status of each facility in the manufacturing factory. The observation data Yⁿ may indicate the number of products manufactured in a line formed of a plurality of facilities. Further, the observation data Xⁿ may indicate a material that serves as a raw material of a product in the manufacturing factory. In this case, the material indicated by the observation data Xⁿ is subjected to one or more processes and then processed into a product. This product is not limited to a product of one kind and may be a plurality of products (e.g., a product A, a product B, and a by-product C). The observation data Yⁿ indicates, for example, the number of products A, the number of products B, and the number of by-products C (or an amount of production etc.)

The observation target and the observation data are not limited to the above-described example and may be, for example, a facility in a processing factory or a construction system in a case in which a facility is constructed.

The observation data Xⁿ and Yⁿ are generated independently in accordance with one real distribution q(x,y)=q(x)q(y|x). The statistical model for guessing a real model q(y|x) can be expressed by p(y|x,θ). The expression q(y|x) indicates the probability that an event y occurs when an event x has occurred. Further, “q(x)q(y|x)” indicates “q(x)×q(y|x)”. In the following description, for the sake of convenience of the description, the operator “×” indicating multiplication is omitted in accordance with mathematical practices.

The regression model r(x,θ) used by the simulator server 200 sets the value of the parameter θ and outputs the value of the data Y upon receiving the input of the value of the data X into the variable x. The simulator server 200 outputs the value of the data Y by performing, for example, an operation including the sample of the parameter θ on the data X (value of x). Note that a function that can be differentiated may not be necessarily used for the model. The simulator server 200 simulates the processing or the operation in the observation target.

When, for example, the observation target is a manufacturing factory, the simulator server 200 calculates the data Y by performing an operation in accordance with the value expressed by the parameter θ on the value of the data X, thereby simulating each process in the manufacturing factory. In this case, the parameter θ indicates, for example, a relation between an input and an output in each process. It can also be said that the parameter θ expresses a state in a process. The number of parameters θ is not limited to one and may be plural. That is, it can also be said that the regression model r(x,θ) collectively expresses the whole processing executed by the simulator server 200 using a symbol r.

Incidentally, Widely Applicable Bayesian Information Criterion (WBIC) has been known as a criterion for evaluating the goodness of a model. For example, when an appropriate model is selected from among a plurality of models, the WBIC of each model is calculated, whereby it is possible to investigate which model is appropriate. The WBIC is a kind of an information criterion that uses Bayes free energy. When the statistical model is a singular model, the WBIC asymptotically approximates a Bayes free energy event and the WBIC matches a Bayesian Information Criterion (BIC) when the statistical model is a regular model. Bayes free energy is defined by the following Expression (1). The symbol π(θ) is a prior distribution regarding the parameter θ.

$$ℱ = - log \int {\prod }_{i = 1}^{n} p ( {Y}_{i} \vert {X}_{i} , θ ) π ( θ ) d θ \qquad \text{<} Expression ( 1 ) \text{>}$$

Now, notation in Bayesian statistical inference will be defined. A minus log likelihood function Lₙ(θ) is defined as shown in the following Expression (2).

$${L}_{n} ( θ ) = - \frac{1}{n} {\sum }_{i = 1}^{n} log p ( {Y}_{i} \vert {X}_{i} , θ ) \qquad \text{<} Expression ( 2 ) \text{>}$$

When the regression problem is modelled by a regression function that involves Gaussian noise, the statistical model (likelihood function) p(y|x,θ) is expressed as shown by the following Expression (3). The statistical model p(y|x,θ) is a model that indicates statistical properties regarding the regression model r(x,θ). However, the regression model r(x,θ) is not always expressed explicitly using a mathematical expression and may indicate, for example, processing such as a simulation in which x and θ are used as inputs and r(x,θ) is used as the output. In general, in the regression model, coefficients of an expression are determined so as to conform to given data. However, the regression model r(x,θ) according to this example embodiment may be a case in which such an expression is not given. That is, it is sufficient that the regression model r(x,θ) according to this example embodiment indicate information in which the inputs x and θ are associated with the output r(x,θ).

$$p ( y \vert x , θ ) = \frac{1}{{\sqrt{2 {πσ}^{2}}}^{d}} exp \{ - \frac{1}{2 {σ}^{2}} {‖ y - r ( x , θ ) ‖}^{2} \} \qquad \text{<} Expression ( 3 ) \text{>}$$

The symbol σ (where σ>0) is a standard deviation of the Gaussian noise. That is, σ is a standard deviation of Gaussian noise in a model defined by a regression function that involves the Gaussian noise. Further, r(x,θ) is a value that the simulator server 200 calculates in accordance with the processing expressed by the regression model. The symbol d is the number of dimensions of X (i.e., the number of pieces of observation data described above). The symbol exp denotes an exponential function having a Napier's constant as a base. The symbol ∥ indicates calculation of a norm. The symbol π denotes a ratio of the circumference of a circle to its diameter.

The WBIC is defined as shown in the following Expression (4). Here, [symbol] _{θ}^{β} denotes an expected value of the posterior distribution of θ. The symbol β (where β>0) denotes a parameter called an inverse temperature.

WBIC= [symbol] _{θ}^{β}[nLₙ(θ)], β=1/log n <Expression (4)>

For any function G(θ) that can be integrated, the expected value of the posterior distribution of θ can be expressed as shown in the following Expression (5).

$${θ}_{β}^{} [ G ( θ ) ] = \frac{\int G ( θ ) {\prod }_{i = 1}^{n} {p ( {Y}_{i} \vert {X}_{i} , θ )}^{β} π ( θ ) d θ}{\int {\prod }_{i = 1}^{n} {p ( {Y}_{i} \vert {X}_{i} , θ )}^{β} π ( θ ) d θ} \qquad \text{<} Expression ( 5 ) >$$

Therefore, by substituting, in Expression (5), nLₙ(θ) into G(θ) and then calculating the right side of Expression (5), the WBIC can be calculated. When, however, the likelihood function p(y|x,θ) cannot be analytically expressed as a mathematical expression, that is, when the likelihood function p(y|x,θ) cannot be differentiated, the right side of Expression (5) cannot be calculated.

By the way, an asymptotical property of the WBIC indicated in the following Expression (6) is known.

[symbol]

=WBIC+ [symbol] (\sqrt{log n}) <Expression (6)>

Expression (6) is established regardless of whether the statistical model is a singular model or a regular model. The symbol [symbol] is a Landau symbol. Therefore, when n is sufficiently large, the item indicated by the Landau symbol can be ignored. That is, the Bayes free energy is approximated by the WBIC.

Now, establishment of Expression (6) will be demonstrated. First, the function Fₙ(β) expressed by the following Expression (7) is defined.

$${F}_{n} ( β ) = - log \int {\prod }_{i = 1}^{n} {p ( {Y}_{i} \vert {X}_{i} , θ )}^{β} π ( θ ) d θ \qquad < Expression ( 7 ) >$$

When Fₙ(β) is defined as above, the Bayes free energy can be expressed as shown by the following Expression (8).

[symbol]

=Fₙ(1) <Expression (8)>

Therefore, Expression (7) is an expression in which the expression of the Bayes free energy is redefined so as to include the inverse temperature.

Further, the function F′ₙ(β) that is obtained by differentiating Fₙ(β) with respect to β can be expressed as shown in the following Expression (9).

$$\begin{matrix}{F}_{n}^{′} ( β ) = \frac{\int {nL}_{n} ( θ ) {\prod }_{i = 1}^{n} {p ( {Y}_{i} \vert {X}_{i} , θ )}^{β} π ( θ ) d θ}{\int {\prod }_{i = 1}^{n} {p ( {Y}_{i} \vert {X}_{i} , θ )}^{β} π ( θ ) d θ} \\ = {θ}_{β}^{} [ {nL}_{n} ( θ ) ] .\end{matrix} \qquad < Expression ( 9 ) >$$

Accordingly, it is seen from Expressions (4) and (9) that F′ₙ(β)=WBIC is established. Further, the following Expression (10) is known as an expression obtained by performing asymptotic expansion on the definition expression of the WBIC.

$${θ}_{β}^{} [ {nL}_{n} ( θ ) ] = {nL}_{n} ( {θ}_{0} ) + \frac{λlog n}{{β}_{0}} + 𝒪 ( \sqrt{log n} ) \qquad < Expression ( 10 ) >$$

In Expression (10), β=β₀/log n. Note that β₀ is a positive constant. Further, λ denotes a real log canonical threshold (RLCT). The symbol θ₀ denotes a real parameter of a statistical model, that is, a parameter that satisfies q(y|x)=p(y|x,θ₀.

On the other hand, as an expression obtained by performing asymptotic expansion on the definition expression of the Bayes free energy, the following Expression (11) is known.

[symbol]

=nLₙ(θ₀)+λ log n+ [symbol] (log log n) <Expression (11)>

Therefore, from these expressions, establishment of Expression (6) is demonstrated.

Further, from the definition of Expression (7) and Expression (6), the following Expression (12) is established. In Expression (12), β=1/log n.

[symbol]

=Fₙ(1)=F′ₙ(β) <Expression (12)>

Next, calculation of the WBIC will be described.

As described above, when the likelihood function p(y|x,θ) cannot be analytically expressed as a mathematical expression, that is, when the likelihood function p(y|x,θ) cannot be differentiated, the right side of Expression (5) cannot be calculated. In this case, it is known that the WBIC can be calculated by calculating the following Expression (13) using sample data that follows the posterior distribution of the parameter θ of a model that predicts the data of the second type. In Expression (13), the sample data that follows the posterior distribution is expressed as follows. \check{θ}ⱼ Here, j denotes an integer that satisfies 1≤j≤m and m denotes the number of pieces of sample data that follows the posterior distribution.

$${θ}_{β}^{} [ {nL}_{n} ( θ ) ] = \frac{1}{m} {\sum }_{j = 1}^{m} {nL}_{n} ( {\check{θ}}_{j} ) \qquad < Expression ( 13 ) >$$

In general, the posterior distribution is unknown. It is therefore required to use a predetermined technique for acquiring a sample that follows the posterior distribution. As a representative method of acquiring the sample that follows the posterior distribution, a method using a Markov Chain Monte Carlo method (MCMC) such as a Metropolis-Hastings algorithm is known. In this method, m pieces of sample data of the parameter θ that follows the posterior distribution p(θ|Xⁿ,Yⁿ) ∝ exp(−βnLₙ(θ)+log π(θ)) of the parameter θ are acquired by the MCMC. The symbol “∝” indicates a proportional relation.

However, when a sample is acquired using the MCMC, in order to obtain m pieces of sample data of θ, simulations whose number is several times larger than m (i.e., prediction of the data of the second type by a model) needs to be performed. Therefore, a lot of calculation costs is required.

On the other hand, in this example embodiment, the sample data of the parameter θ is acquired using Kernel Approximate Bayesian Computation (kernel ABC) and predetermined processing (Kernel Herding etc.)

The kernel ABC is an algorithm that estimates a posterior distribution by calculating the kernel mean. In the kernel ABC, the simulation is performed based on m pieces of sample data and the weight (importance) of the sample data of m parameters is determined based on the observation data observed regarding the observation target, whereby the posterior distribution can be obtained. For example, as the simulation results are more similar to the observation data, a weight that puts more emphasis on the parameters used for the results of the simulation is calculated. In contrast, as the simulation results are less similar to the observation data, a weight that puts less emphasis on the parameters used for the results of the simulation is calculated.

Kernel Herding (one example of predetermined processing) is an algorithm that acquires a sample in accordance with a posterior distribution from the kernel mean indicating the posterior distribution. Kernel Herding sequentially determines a sample that becomes the closest to the obtained kernel mean. In this example embodiment, m new samples are calculated for m samples by the kernel ABC and the processing in Kernel Herding. Therefore, it can also be said that the value of the sample is adjusted.

While Kernel Herding is a method of sequentially determining samples, the predetermined processing for acquiring the samples that follow the posterior distribution (in this example embodiment, the estimated posterior distribution) is not limited to Kernel Herding. That is, it is sufficient that the predetermined processing be a method of generating samples that follow the posterior distribution (in this example embodiment, the estimated posterior distribution).

When the sample data of the parameter θ is acquired using the kernel ABC and the above predetermined processing (e.g., Kernel Herding), it is sufficient that m simulations (i.e., prediction of the data of the second type by a model) be performed in order to obtain m pieces of sample data of θ. It is therefore possible to reduce the calculation cost. In particular, in this example embodiment, the information criterion calculation apparatus 100 that acquires the sample data of the parameter θ that follows the posterior distribution including the inverse temperature β using the kernel ABC and Kernel Herding and calculates the WBIC based on its sample data will be described.

It can also be said that the inverse temperature β indicates a value indicating the level at which the influence of the distribution calculated based on each of the samples on the estimated distribution is leveled in processing of estimating the posterior distribution. In this case, the higher the inverse temperature β becomes, the lower the level to be leveled becomes. In other words, as the inverse temperature β becomes higher, the estimated distribution is more affected by each distribution. On the other hand, the lower the inverse temperature β becomes, the higher the level to be leveled becomes. In other words, as the inverse temperature β becomes lower, the estimated distribution is less affected by some distributions.

Hereinafter, the information criterion calculation apparatus 100 will be specifically described.

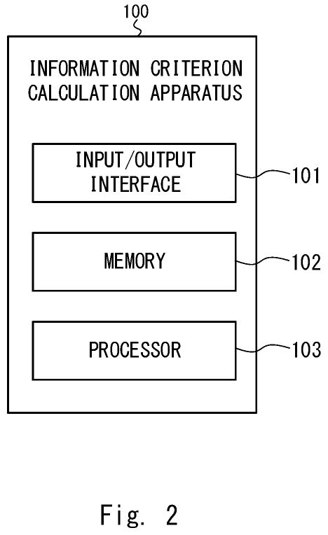

FIG. 2 is a block diagram showing one example of a hardware configuration of the information criterion calculation apparatus 100. The information criterion calculation apparatus 100 includes an input/output interface 101, a memory 102, and a processor 103.

The input/output interface 101 is an interface that inputs/outputs data. The input/output interface 101 is used, for example, to communicate with another apparatus. In this case, the input/output interface 101 is used, for example, to communicate with the simulator server 200. The input/output interface 101 may be used to communicate with an external apparatus such as a sensor apparatus that outputs the observation data Xⁿ or the observation data Yⁿ. Further, the input/output interface 101 may further include an interface connected to an input device such as a keyboard and a mouse. In this case, the input/output interface 101 acquires data input by user's operations. Further, the input/output interface 101 may further include an interface connected to a display. In this case, for example, operation results of the information criterion calculation apparatus 100 and the like are displayed on a display via the input/output interface 101.

The memory 102 includes, for example, a combination of a volatile memory and a non-volatile memory. The memory 102 is used to store various kinds of data used for the processing of the information criterion calculation apparatus 100, software (computer program) or the like including one or more instructions executed by the processor 103.

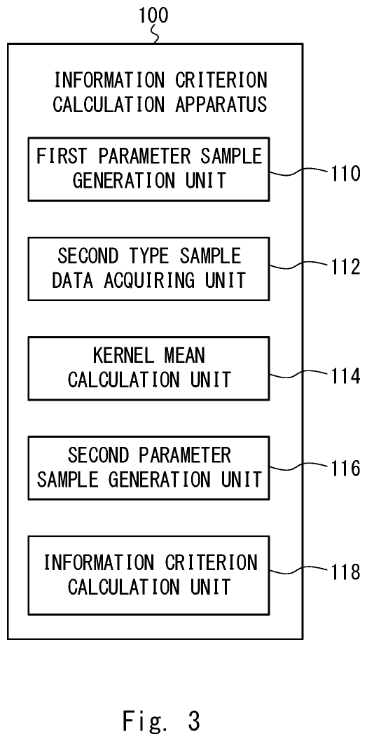

The processor 103 loads software (computer program) from the memory 102 and executes the loaded software, thereby performing processing of the respective components shown in FIG. 3 that will be described later. The processor 103 may be, for example, a microprocessor, a Micro Processor Unit (MPU), or a Central Processing Unit (CPU). The processor 103 may include a plurality of processors.

Further, the above-described program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

FIG. 3 is a block diagram showing one example of a functional configuration of the information criterion calculation apparatus 100. The information criterion calculation apparatus 100 includes a first parameter sample generation unit 110, a second type sample data acquiring unit 112, a kernel mean calculation unit 114, a second parameter sample generation unit 116, and an information criterion calculation unit 118. The first parameter sample generation unit 110 is also referred to as a a priori parameter sample generation unit, the kernel mean calculation unit 114 is also referred to as a corresponding data calculation unit, and the second parameter sample generation unit 116 is also referred to as a new parameter sample generation unit.

The first parameter sample generation unit 110 generates the sample data of the parameter θ based on the prior distribution π(θ) of the parameter θ of the regression model r(x,θ) that outputs the data of the second type (data Y) upon receiving the input of the data of the first type (data X). The prior distribution π(θ) is, for example, a uniform distribution. When the prior distribution π(θ) is a uniform distribution, the sample data is randomly selected from a domain where the value of θ is defined. When the distribution that is estimated to be close to the posterior distribution to some extent is obtained, this distribution may be set to be the prior distribution π(θ). In this case, the sample data is selected from this domain in accordance with the prior distribution π(θ). The prior distribution π(θ) is not limited to the above-described example and it is not necessarily explicitly given. When the prior distribution π(θ) is not explicitly given, the prior distribution π(θ) is set, for example, to be a uniform distribution. Further, as will be described later, the prior distribution π(θ) may be set by the user.

That is, when the number of pieces of sample data generated by the first parameter sample generation unit 110 is denoted by m (m is a positive integer) and j denotes an integer that satisfies 1≤j≤m, the sample data of the parameter θ is expressed as shown in the following Expression (14). The symbol de denotes the number of dimensions of the parameters (i.e., the number of types of the parameters θ). That is, Expression (14) indicates that the number of sets including d_{θ} types of parameters is m. The symbol R denotes a real number.

As shown in Expression (14), the sample data of the parameter θ is indicated as a d_{θ}-dimensional real number and follows the prior distribution π(θ). The prior distribution π(θ) is stored in the memory 102 in advance. The prior distribution π(θ) is, for example, set in advance with an accuracy in accordance with the knowledge that the user has about the simulation target.

θ̅ⱼ ∈ [symbol] ^{d}^{_{θ}}˜π(θ) for j=1, . . . , m <Expression (14)>

The second type sample data acquiring unit 112 receives the parameter θ generated by the first parameter sample generation unit 110 and inputs the m received parameters θ into the simulator server 200 along with the observation data (observation data Xⁿ) of the data of the first type. The m parameters θ and the observation data (observation data Xⁿ) of the data of the first type are input to the simulator server 200.

The simulator server 200 executes, for each of the m input parameters θ, simulation calculation based on the observation data (observation data Xⁿ) of the data of the first type. That is, the simulator server 200 executes m types of simulation calculations regarding the observation target in accordance with the m input parameters θ. The simulator server 200 executes m types of simulation calculations, thereby calculating m types of simulation results (Y̅ⁿ).

The second type sample data acquiring unit 112 acquires them types of simulation results from the simulator server 200 as sample data of the second type. The above-described processing can be mathematically expressed as follows.

The second type sample data acquiring unit 112 acquires, for each of the pieces of the sample data of the parameter, sample data that has n (the same number as the number of elements of the observation data Xⁿ) elements and is expressed as shown in Expression (15) from the model (simulator server 200).

Y̅ⱼⁿ ∈ [symbol] ⁿ˜p(y|θ̅ⱼ) <Expression (15)>

As shown in Expression (15), the sample data acquired by the second type sample data acquiring unit 112 is indicated as an n-dimensional real number and follows the distribution in which the sample data of the parameter is input to the likelihood function p(y|θ) of the regression model r(x,θ).

The kernel mean calculation unit 114 estimates the kernel mean indicating the posterior distribution of the parameters in accordance with the kernel ABC.

That is, the kernel mean calculation unit 114 calculates the kernel mean indicating the posterior distribution of the parameters based on the sample data of the parameter and the sample data of the second type. In particular, the kernel mean calculation unit 114 calculates the kernel mean using the kernel function including the inverse temperature.

Now, the kernel ABC will be described. In the kernel ABC, the kernel mean expressed by the following Expression (16) is calculated using the sample data expressed by Expression (14) and the sample data expressed by Expression (15). The kernel mean corresponds to the posterior distribution expressed on a Reproducing Kernel Hilbert Space (RKHS) by Kernel Mean Embeddings. The kernel mean is one example of data that corresponds to distribution of the parameters (posterior distribution).

$${\hat{μ}}_{θ \vert Y} = {\sum }_{j = 1}^{m} {w}_{j} {\overline{θ}}_{j} ∈ ℋ . \qquad < Expression ( 16 ) >$$

The weight wⱼ is expressed as shown in the following Expression (17). The symbol H denotes a Reproducing Kernel Hilbert Space. That is, the larger the weight (importance) wⱼ becomes, the stronger the influence the kernel regarding the sample θ̅ⱼ on the mean becomes. The smaller the weight wⱼ becomes, the weaker the influence the kernel regarding the sample θ̅ⱼ on the mean becomes.

$$\begin{matrix}w = {( {w}_{1} , … , {w}_{m} )}^{T} ∈ {m}^{} \\ {( G + m δ I )}^{- 1} {k}_{y} ( {Y}^{n} ) .\end{matrix} \qquad < Expression ( 17 ) >$$

Note that the superscript T indicates transposition of a matrix or a vector. Further, I denotes an identity matrix and δ (where δ>0) denotes a regularization constant. Further, the vector k_{y}(Yⁿ) and a Gram Matrix G are expressed as shown in the following Expressions (18) and (19) by the kernel k_{y} with respect to the data vector Yⁿ composed of an element of a real number. The symbol k_{y}(Yⁿ) denotes a function of calculating the closeness (norm) between the observation data Yⁿ and the sample data in Expression (15) that corresponds to the above observation data Yⁿ, i.e., the similarity between them. In other words, from Expression (18), the similarity between each of m types of simulation results that the simulator server 200 has output with respect to the observation data (observation data Xⁿ) and the observation data that the observation target has actually output with respect to the observation data. The kernel mean is a weighted mean that is calculated in accordance with the processing shown in Expression (16) using the weight of each parameter determined using the calculated similarity.

k_{y}(Yⁿ)=(k_{y}(Y̅₁ⁿ,Yⁿ), . . . , k_{y}(Y̅ₘⁿ,Yⁿ))^{T} ∈ [symbol] ^{m} <Expression (18)>

G=(k_{y}(Y̅ⱼⁿ,Y̅_{j′}ⁿ))_{j,j′=1}^{m} ∈ [symbol] ^{m×m} <Expression (19)>

It can also be said that Expression (18) calculates the difference between a plurality of pieces of observation information observed when the input is given to the observation target and the data of the second type generated by the simulator server 200 with respect to the plurality of samples and the data of the first type indicating the input. Further, it can also be said that Expression (16) expresses processing of calculating a large weight for data that is similar to the observation data that has been actually observed regarding the observation target among m types of simulation results. Likewise, it can also be said that Expression (16) expresses processing of calculating a small weight for data that is not similar to the observation data that has been actually observed regarding the observation target among the m types of simulation results. That is, it can also be said that Expression (17) calculated using Expression (18) expresses processing of calculating a weight in accordance with the degree that the result of the simulation and the observation data are similar to each other. It can also be said that this is processing that uses Covariate Shift.

In the kernel ABC with respect to Covariate Shift, while the distribution q₀(x) that the training data set {Xⁿ,Yⁿ} follows is different from the distribution q₁(x) that the data set for testing or predicting follows, a real function relation p(y|x) is the same. That is, Covariate Shift indicates that, while the processing of calculating y with respect to a given x is constant for a plurality of x, the distribution, which is the input, at the time of training is different from that at the time of testing. It is assumed here that the probability densities q₀(x) and q₁(x) have already been given or the ratio thereof q₀(x)/q₁(x) has already been given. In this case, as this ratio becomes closer to 1, it is indicated that q₀(x) at the time of training and q₁(x) at the time of testing occur at probabilities similar to each other. As this ratio becomes larger than 1, it is indicated that the probability at the time of training becomes higher than that at the time of testing. Further, as this ratio becomes smaller than 1, the probability at the time of testing becomes higher than that at the time of training. That is, this ratio is an index indicating which one of the distribution at the time of training and the distribution at the time of testing the data x is close to. This index is not limited to the ratio and may be, for example, an index indicating the difference between the distribution at the time of training and the distribution at the time of testing, like the difference between both distributions. When the probability densities q₀(x) and q₁(x) have already been given or when the ratio of them q₀(x)/q₁(x) has already been given, the kernel function k_{y} on the right side of Expressions (18) and (19) can be expressed as shown in the following Expression (20). Expression (20) corresponds to Expression (25) that will be shown later except for the difference regarding whether or not the inverse temperature depends on the training data (observation data).

$${k}_{y}^{( {β}_{i} )} ( {Y}^{n} , {Y}^{{n}^{′}} ) = exp \{ - \frac{1}{2 {σ}^{2}} {\sum }_{i = 1}^{n} {{β}_{i} ( {Y}_{i} - {Y}_{i}^{′} )}^{2} \} \qquad < Expression ( 20 ) >$$

Note that (Yⁿ,Y^{n′}) on the left side of Expression (20) indicates that the kernel function is a function of two variables regarding the data of the second type expressed by an n-dimensional vector (a data set whose number of elements is n (i.e., including n elements)). That is, Yⁿ on the left side indicates a first variable in the function of two variables and Y^{n′} on the left side indicates a second variable in the function of two variables. Then Yᵢ on the right side indicates the i-th element of the n-dimensional vector input to the function of two variables as the first variable. Further, Yⁱ′ on the right side indicates the i-th element of the n-dimensional vector input to the function of two variables as the second variable.

In Expression (20), σ is a standard deviation of the Gaussian noise regarding the data of the second type. More specifically, in Expression (20), σ is a standard deviation of the distribution composed of the whole observation data of the data of the second type used to calculate Expression (20). In particular, it can be said that σ in Expression (20) means a value indicating a scale for measuring the similarity between the distribution of the observation data of the second type and the distribution of the sample data of the second type. Further, n denotes the number of pieces of data of the second type and βᵢ denotes the inverse temperature, and Yᵢ and Yᵢ′ each denote a value of the data of the second type. That is, in Expression (20), each of the elements included in the data set of the second type (e.g., the type of the observation data) is weighted by βᵢ, which is the inverse temperature. In other words, by appropriately setting βᵢ, which is the inverse temperature, it becomes possible to give different priorities to each type of the data of the second type.

In Expression (20), βᵢ denotes the inverse temperature that depends on the training data (observation data) {Xᵢ,Yᵢ}. That is, values of the inverse temperatures may be set so as to be different from one another for each of the pieces of data. That is, the inverse temperature βᵢ can be set for each of the types of the observation data (i.e., elements included in Yⁿ). For example, a larger value is set for the inverse temperature for a type of observation data whose importance level is high and a smaller value is set for the inverse temperature for a type of observation data whose importance level is low. Therefore, it can also be said that βᵢ indicates the contribution degree indicating the importance of the type of the observation data (i.e., elements included in Yⁿ). That is, it can be said that the inverse temperature is the contribution degree of each of the pieces of observation information in the plurality of pieces of observation information.

In this example embodiment, the kernel means is calculated for a constant inverse temperature that does not depend on the training data (observation data) {Xᵢ,Yᵢ}. Specifically, the kernel mean calculation unit 114 calculates the kernel mean indicated by the following Expression (21).

$${\hat{μ}}_{ϑ \vert YX} = {\sum }_{j = 1}^{m} {\tilde{w}}_{j} {\overline{θ}}_{j} . \qquad < Expression ( 21 ) >$$

The weight \tilde{w}ⱼ is indicated as shown in the following Expression (22).

$$\begin{matrix}\tilde{w} = {( {\tilde{w}}_{1} , … , {\tilde{w}}_{m} )}^{2} ∈ {ℝ}^{m} \\ = {( \tilde{G} + m δ I )}^{- 1} {\tilde{k}}_{y} ( {Y}^{n} ) .\end{matrix} \qquad < Expression ( 22 ) >$$

The vector \tilde{k}_{y}(Yⁿ) and the gram matrix \tilde{G} are indicated as shown by the following Expressions (23) and (24) by the kernel \tilde{k}_{y} with respect to the data vector Yⁿ composed of an element of a real number.

\tilde{k}_{y}(Yⁿ)=(\tilde{k}_{y}(Y̅₁ⁿ,Yⁿ), . . . , \tilde{k}_{y}(Y̅ₘⁿ,Yⁿ))^{T} ∈ [symbol] ^{m} <Expression (23)>

\tilde{G}=(\tilde{k}_{y}(Y̅ⱼⁿ,Y̅_{j′}ⁿ))_{j,j′=1}^{m} ∈ [symbol] ^{m×m} <Expression (24)>

Here, the kernel function on the right side in Expressions (23) and (24) \tilde{k}_{y} can be expressed as shown in the following Expression (25).

$${\tilde{k}}_{y} ( {Y}^{n} , {Y}^{{n}^{′}} ) = exp \{ - \frac{1}{2 {σ}^{2}} {\sum }_{i = 1}^{n} {β ( {Y}_{i} - {Y}_{i}^{′} )}^{2} \} \qquad < Expression ( 25 ) >$$

Note that (Yⁿ,Y^{n′}) on the left side of Expression (25) indicates that the kernel function is a function of two variables regarding the data of the second type expressed by an n-dimensional vector (a data set whose number of elements is n (i.e., including n elements)). That is, Yⁿ on the left side denotes the first variable in the function of two variables and Y^{n′} on the left side denotes the second variable in the function of two variables. The symbol Yᵢ on the right side denotes the i-th element of the n-dimensional vector input to the function of two variables as the first variable. Further, the symbol Yᵢ′ on the right side denotes the i-th element of the n-dimensional vector input to the function of two variables as the second variable.

Comparing the processing shown in Expression (20) with the processing shown in Expression (25), each of the elements included in the data set of the second type (e.g., type of the observation data) is weighted by βᵢ, which is the inverse temperature in Expression (20). On the other hand, in Expression (25), the elements included in the data set of the second type (e.g., type of the observation data) are weighted by a constant inverse temperature. That is, the processing shown in Expression (25) indicates that the contribution degree of the elements included in the data set of the second type is constant. While it is assumed in the example that the contribution degree is constant, the term “constant” is not limited to “constant” that can be mathematically defined and may be substantially constant. A value that is substantially constant indicates, for example, a value calculated by adding noise of a mean 0 standard deviation s to an average value a. In this case, the standard deviation s is, for example, a value of about 0% to 10% of the magnitude of a.

In Expression (25), σ is a standard deviation of Gaussian noise regarding the data of the second type. More specifically, in Expression (25), σ is a standard deviation of the distribution composed of the entire observation data of the data of the second type used to calculate Expression (25). In particular, it can be said that σ in Expression (25) indicates the value indicating the scale for measuring the similarity between the distribution of the observation data of the second type and the distribution of the sample data of the second type. Further, n denotes the number of pieces of data of the second type, β denotes the inverse temperature, and Yᵢ and Yᵢ′ are values of the data of the second type. The symbol β is a constant that does not depend on observation data.

The second parameter sample generation unit 116 generates the sample data of the parameters that follow the posterior distribution that is defined using the inverse temperature based on the kernel mean calculated by the kernel mean calculation unit 114. Here, the posterior distribution defined using the inverse temperature is defined from the prior distribution and the likelihood function controlled by the inverse temperature based on Bayes' theorem. Therefore, the posterior distribution is distribution that follows exp(−βnLₙ(θ)+log π(θ)).

Specifically, the second parameter sample generation unit 116 generates the sample data of the parameters that follow the posterior distribution using Kernel Herding. In Kernel Herding, by the update expression shown in the following Expression (26) and (27), m pieces of sample data θ₁, . . . , θₘ that follow the posterior distribution are generated.

θⱼ₊₁=argmax_{θ}hⱼ(θ) <Expression (26)>

hⱼ₊₁=hⱼ+μ−θⱼ₊₁ ∈ [symbol] <Expression (27)>

Here, j=0, . . . , m−1. Further, argmax₇₄ hⱼ(θ) indicates a value of θ that maximizes the value of hⱼ(θ). The symbol hⱼ is sequentially indicated by Expression (27). For the initial value h₀ of hⱼ and μ, the value of the kernel mean calculated in accordance with the processing shown in Expression (21) is used. That is, the second parameter sample generation unit 116 generates, using the kernel mean calculated by the kernel mean calculation unit 114, m pieces of sample data θ₁, . . . , θₘ that are suitable for expressing the kernel mean by predetermined processing such as Kernel Herding. In other words, the information criterion calculation apparatus 100 executes processing of calculating m pieces of sample data that follows the estimated posterior distribution for m pieces of sample data in accordance with the prior distribution. Therefore, it can also be said that the processing in the information criterion calculation apparatus 100 is processing of adjusting values of m pieces of sample data.

The information criterion calculation unit 118 calculates the WBIC regarding the model based on the sample data of the parameters generated by the second parameter sample generation unit 116. Specifically, the information criterion calculation unit 118 calculates the WBIC using the sample data of the parameters generated by the second parameter sample generation unit 116 and Expression (13).

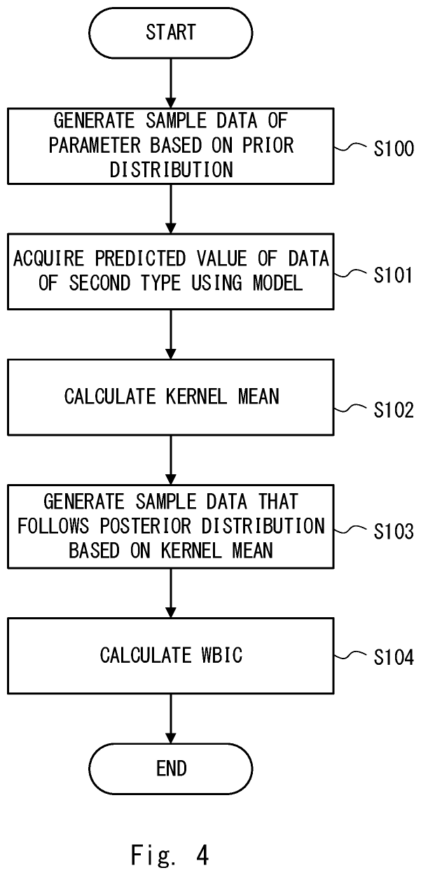

Next, an operation of the information criterion calculation apparatus 100 will be described based on a flowchart. FIG. 4 is a flowchart showing one example of the operation of the information criterion calculation apparatus 100. Hereinafter, with reference to FIG. 4, this operation will be described.

In Step S100, the first parameter sample generation unit 110 generates sample data of the parameter θ based on the prior distribution π(θ). The sample data generated by the first parameter sample generation unit 110 is input to the simulator server 200. In this example embodiment, as one example, the generated sample data is input to the simulator server 200 by the second type sample data acquiring unit 112.

Next, in Step S101, the second type sample data acquiring unit 112 acquires the sample data of the second type calculated by the simulator server 200 in accordance with a model in which the sample data generated in Step S100 is set as a parameter. That is, the second type sample data acquiring unit 112 inputs Xⁿ, which is the data of the first type, of the training data set {Xⁿ,Yⁿ} acquired in advance to a model, and acquires the output from the model. The training data set {Xⁿ,Yⁿ} is information in which Xⁿ , which is the data of the first type, is associated with Yⁿ, which is the data of the second type. In this case, Yⁿ, which is the data of the second type, indicates, for example, information observed regarding the observation target by the observation target actually performing processing (operation) on Xⁿ, which is the data of the first type.

As described above, the simulator server 200 calculates the data Y by performing the operation in accordance with the value indicated by the parameter θ on the value of the data X. Accordingly, the processing (operation) in the observation target is simulated. In this case, the parameter θ indicates, for example, the relationship between the input and the output in each processing (operation).

In Step S101, the simulator server 200 receives, as an input, Xⁿ, which is the data of the first type, indicating the input given to the observation target and performs the processing in accordance with the input parameter θ on Xⁿ, which is the data of the first type, thereby simulating the observation target. As a result, the simulator server 200 generates simulation results (Y̅ⁿ) indicating the results of the simulation.

The processing in the simulator server 200 may be executed in advance. In this case, the second type sample data acquiring unit 112 reads out information in which the sample data of the parameter θ is associated with the simulation results calculated when the sample data has been set.

Next, in Step S102, the kernel mean calculation unit 114 calculates the kernel mean indicating the posterior distribution of the parameters by kernel ABC using the sample data obtained in Steps S100 and S101. As described above, this posterior distribution is defined using the inverse temperature. The kernel mean calculation unit 114 calculates the kernel mean using the kernel function including the inverse temperature shown by Expression (25). In other words, the kernel mean calculation unit 114 determines the importance of the respective samples of the parameters in accordance with the difference between the observation data and the sample data regarding the data of the second type and the contribution degree of each of the pieces of observation data, thereby calculating the data that corresponds to the distribution of the parameters.

Next, in Step S103, the second parameter sample generation unit 116 generates the sample data of the parameters that follow the posterior distribution defined using the inverse temperature based on the kernel mean calculated in Step S102.

Next, in Step S104, the information criterion calculation unit 118 calculates the WBIC regarding the model using Expression (13) based on the sample data of the parameters generated in Step S103.

The first example embodiment has been described above. In this example embodiment, the kernel mean that corresponds to the posterior distribution defined using the inverse temperature is calculated by the kernel mean calculation unit 114. Therefore, even when a value other than 1 is set as the value of the inverse temperature, the sample data of the posterior distribution can be acquired using a method such as kernel ABC, Kernel Herding and the like. In the method such as kernel ABC, Kernel Herding and the like, it is sufficient that the second type sample data acquiring unit 112 acquire the sample data that can be expressed as shown in Expression (15) from the model (the simulator server 200) for each of the pieces of the sample data of the parameters. That is, compared to the case of acquiring the sample data of the posterior distribution by the method using the MCMC, the number of times the simulation is executed can be reduced. That is, according to this example embodiment, it is possible to efficiently calculate parameters. It is therefore possible to efficiently calculate the WBIC.

While the sample data generated in Step S103 is used only to calculate the WBIC in the flowchart shown in FIG. 4, it may also be used for performing simulation by the simulator server 200. That is, the information criterion calculation apparatus 100 may input the sample data generated in Step S103 (i.e., the sample data of the parameter θ) into the simulator server 200. In this case, the simulator server 200 receives m pieces of the sample data and executes the simulation calculation regarding the observation target based on the received sample data. Specifically, the simulator server 200 executes m kinds of simulation processing in accordance with the sample data for Xⁿ, which is the given data of the first type. As a result, the simulator server 200 calculates m types of simulation results for Xⁿ, which is the given data of the first type. The m types of simulation results are not necessarily different from one another and may include the same results.

After that, the information criterion calculation apparatus 100 receives m types of simulation results. Then the information criterion calculation apparatus 100 calculates simulation results in which m types of simulation results are synthesized. The information criterion calculation apparatus 100 calculates, for example, the average of m types of simulation results. That is, the information criterion calculation apparatus 100 calculates the simulation results for Xⁿ, which is the given data of the first type. The information criterion calculation apparatus 100 may calculate the simulation results for Xⁿ, which is the given data of the first type by calculating, for example, the weighted mean of m types of simulation results.

The information criterion calculation apparatus 100 executes the processing stated above with reference to FIG. 4, thereby calculating the sample data of the parameter θ in such a way that the simulation results calculated by the simulator server 200 match (conform to) the observation information Yⁿ. Since the calculated sample data is data that follows the posterior distribution, the aforementioned simulation results calculated by the information criterion calculation apparatus 100 are simulation results in accordance with the sample data that follows the posterior distribution. In other words, the information criterion calculation apparatus 100 is able to calculate the simulation results that match the observation information based on the simulation results generated by the simulator server 200. Therefore, by generating a value that conforms to the observation information regarding the sample data of the parameter θ given to the simulator server 200, the information criterion calculation apparatus 100 is able to calculate the simulation results that conform to this observation information.

### Second Example Embodiment

Next, a second example embodiment will be described. Depending on the characteristics of the kernel ABC, the method of calculating the WBIC shown in the first example embodiment may bring about results that are different from the results of the calculation of the WBIC that uses the MCMC method. This may be due to the following reason.

The practical restriction of the kernel ABC algorithm is that an adjusted value needs to be used as a hyper parameter σ, which is a width of the kernel k_{y}(Yⁿ,Y^{n′}) for measuring the similarity between the data Yⁿ and the data Y^{n′}. In order to indicate the distribution of k_{y}(Yⁿ,Y^{n′}) with respect to all the regions of a section [0,1], it is required to perform accurate calculation in Expression (25). When σ is much smaller than the adjusted hyper parameter σₖ, it is possible that the distribution of the values of k_{y}(Yⁿ,Y^{n′}) may concentrate on a small value (e.g., smaller than 0.1) and it is thus possible that the result of the calculation in Expression (25) may be inaccurate. The reason therefor is that the scale for measuring the similarity of the data is much smaller than the scale of the data Yⁿ.

On the other hand, σ is a hyper parameter of the standard deviation of the Gaussian noise in Expression (3). The symbol nLₙ(θ) is calculated using this hyper parameter. It is possible, however, that the above-described hyper parameter σₖ may be larger than the real standard deviation value σ₀ of the Gaussian noise. Due to the difference between σ₀ and σₖ, the value of the WBIC calculated using the kernel ABC ends up being different from the value of the WBIC calculated by directly using the likelihood function, like in the MCMC method.

That is, when the WBIC is calculated, σₖ is used, not σ₀, as a specific value of σ in Expression (25). Therefore, it is possible that the accurate value of the WBIC may not be calculated in the first example embodiment. It is assumed here that the model is modelled by a regression function that involves the Gaussian noise. It can be said that σ₀ denotes a value of standard deviation of this Gaussian noise with respect to the regression function. It can be further said that σₖ is a value indicating the scale for measuring the similarity between the distribution of the observation data of the second type and the distribution of the sample data of the second type.

This example embodiment shows a method of calculating the WBIC more accurately than in the method of calculating the WBIC shown in the first example embodiment. It is assumed, in this example embodiment, that the standard deviation σ₀ of the Gaussian noise has already been given. That is, before making a correction that will be described later, the standard deviation σ₀ of the Gaussian noise is estimated by a known method and has already been given.

In the following description, in order to explicitly express the hyper parameter σ of the model, Expression (7) is expressed by Fₙ(β,σ), not Fₙ(β). Further, β and σ indicate variables. A signal such as β₁ in which subscript is added to β indicates a specific constant. Likewise, a signal such as σ₀ in which subscript is added to σ indicates a specific constant. The object of this example embodiment is to calculate WBIC=Fₙ(1,σ₀)=F′ₙ(β,σ₀) from Fₙ(1,σₖ)=F′ₙ(β,σₖ). This is because F′ₙ (β,σₖ) is calculated as the WBIC in the information criterion calculation apparatus 100 according to the first example embodiment.

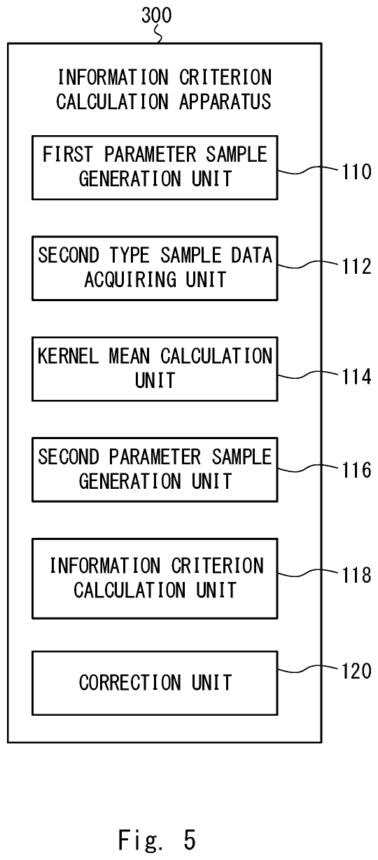

In the second example embodiment, in the information processing system 10, an information criterion calculation apparatus 300 is used in place of the information criterion calculation apparatus 100. FIG. 5 is a block diagram showing one example of a functional configuration of the information criterion calculation apparatus 300 according to the second example embodiment. The information criterion calculation apparatus 300 is different from the information criterion calculation apparatus 100 according to the first example embodiment in that the information criterion calculation apparatus 300 further includes a correction unit 120. The information criterion calculation apparatus 300 also includes a hardware configuration as shown in FIG. 2, like in the information criterion calculation apparatus 100. The processor 103 loads software from the memory 102 and executes the loaded software, thereby performing processing of each configuration shown in FIG. 5.

The correction unit 120 corrects the WBIC calculated by the information criterion calculation unit 118. The correction unit 120 performs correction using the fact that different σ are expressed by different inverse temperatures β in the relational expression derived from Expressions (7) and (3). The relation of Fₙ(β,σ) between different σ and β is expressed by the following Expression (28).

Fₙ(1,σₖ)=Fₙ(βₖ,σ₀)+Cₖ <Expression (28)>

In Expression (28), Cₖ and βₖ are defined as expressed by the following Expressions (29) and (30).

$$\begin{matrix}{C}_{k} = \frac{nd}{2} \{ log {β}_{k} + ( {β}_{k} - 1 ) log ( 2 {πσ}_{0}^{2} ) \} & < Expression ( 29 ) > \\ {β}_{k} = {( \frac{{σ}_{0}}{{σ}_{k}} )}^{2} & < Expression ( 30 ) >\end{matrix}$$

Expression (28) indicates a relation between the WBIC when the value of the inverse temperature is set to 1 and the value of the standard deviation is set to σₖ in Expression (7) and the WBIC when the value of the inverse temperature is set to a predetermined value βₖ other than 1 and the value of the standard deviation is set to σ₀ in Expression (7). As described above, Expression (7) is a mathematical expression obtained by redefining the expression of the Bayes free energy so as to include the inverse temperature. The correction unit 120 corrects the WBIC calculated by the information criterion calculation unit 118 using the relation expressed by Expression (28).

Specifically, the correction unit 120 performs correction by one of the two correction methods described below. In order to describe two correction methods, a mathematical expression that is obtained by performing asymptotic expansion on Fₙ(β,σ), that is, the mathematical expression shown in Expression (7), is shown. The following Expression (31) is a mathematical expression that is obtained by performing asymptotic expansion regarding Fₙ(β,σ).

Fₙ(β,σ)=nβLₙ(θ₀)+λ log n+ [symbol] (\sqrt{log n}) <Expression (31)>

### <First Correction Method>

In this case, the correction unit 120 corrects the WBIC calculated by the information criterion calculation unit 118 by using a relation expressed by excluding the real log canonical threshold λ obtained from two expressions in which different values of β are set in Expression (31), and the relation expressed by Expression (28). Since the relation in which the real log canonical threshold λ has been excluded is used, in the first method, the WBIC can be corrected without calculating the real log canonical threshold λ, which is typically difficult to be calculated.

Specifically, the two expressions are an expression in which the inverse temperature β=1 is set (the following Expression (32)) and an expression in which the inverse temperature β=β₁ (where β₁ is a constant other than 1) is set (the following Expression (33)). The number 1 and the symbol β₁ correspond to βₖ. In any expression, σ=σ₀. The relational expression indicating the relation expressed by excluding the real log canonical threshold λ can be obtained by deleting the item of the real log canonical threshold λ in the simultaneous equations composed of Expressions (32) and (33).

Fₙ(1,σ₀)=nLₙ(θ₀)+λ log n+ [symbol] (\sqrt{log n}) <Expression (31)>

Fₙ(β₁,σ₀)=nβ₁Lₙ(θ₀)+λ log n+ [symbol] (\sqrt{log n}) <Expression (33)>

Here, when the entropy (minus log likelihood function) Lₙ(θ₀) can be sufficiently approximated by Lₙ(\hat{θ}) (where \hat{θ} is a mean (posterior mean) calculated from the sample data of the parameters that follow the posterior distribution), the following Expression (34) is established. Expression (34) is obtained by the relational expression indicating a relation expressed by excluding the real log canonical threshold 2 and the relational expression expressed by Expression (28).

$$\begin{matrix}WBIC = {F}_{n} ( 1 , {σ}_{0} ) \\ = {F}_{n} ( 1 , {σ}_{1} ) + ( 1 - {β}_{1} ) {nL}_{n} ( \hat{θ} )\end{matrix} \qquad < Expression ( 34 ) >$$

In Expression (34), σ₁ that corresponds to the above σₖ is a hyper parameter regarding the width of the kernel. Further, β₁=σ₀²/σ₁² (see Expression (30)). Fₙ(1,σₖ) corresponds to the WBIC calculated by the information criterion calculation unit 118. Therefore, the correction unit 120 generates the WBIC after the correction from the WBIC before correction calculated by the information criterion calculation unit 118 by calculating Expression (34). In other words, the correction unit 120 calculates, regarding the parameter set that follows the estimated posterior distribution, a minus log likelihood function Lₙ(θ₀) that can also be said as likelihood (a level of likelihood) regarding the data of the first type (i.e., the input to the observation target) and the observation information observed regarding the observation target in the case of the data of the first type. Then the correction unit 120 calculates the correction amount using the calculated likelihood and the ratio of the widths described above. Then the correction unit 120 performs correction so as to add the correction amount to the WBIC before correction calculated by the information criterion calculation unit 118.

### <Second Correction Method>

When it is possible to perform calculation of Lₙ(θ₀) by approximation, it is sufficient that the correction unit 120 may perform correction by the above first correction method. However, when it is impossible to perform calculation of Lₙ(θ₀) by approximation, the first correction method cannot be used. In this case, it is sufficient that the correction unit 120 may perform correction by the second correction method.

In the second correction method, the correction unit 120 corrects the WBIC calculated by the information criterion calculation unit 118 by using the relation expressed by excluding a real log canonical threshold and entropy obtained from the three expressions in which different values of β are set in Expression (31) and the relation expressed by Expression (28). Since the relation in which the entropy has been excluded in addition to the real log canonical threshold is used, according to the second correction method, the correction can be performed even when it is impossible to perform calculation of Lₙ(θ₀) by the approximation.

Specifically, the three expressions are an expression where the inverse temperature β=1 is set (the following Expression (35)), an expression where the inverse temperature β=β₁ is set (the following Expression (36)), and an expression where the inverse temperature β=β₂ is set (the following Expression (37)). The number 1 and symbols β₁ and β₂ correspond to βₖ. In any expression, σ=σ₀.

Note that β₁ is a constant other than 1 and β₂ is a constant other than β₁ or 1. Specifically, β₁=σ₁²/σ₁² and β₂=σ₀²/σ₂². Note that σ₂≠σ₁.

Fₙ(1,σ₀)=nLₙ(θ₀)+λ log n+ [symbol] (\sqrt{log n}) <Expression (35)>

Fₙ(β₁,σ₀)=nβ₁Lₙ(θ₀)+λ log n+ [symbol] (\sqrt{log n}) <Expression (36)>

Fₙ(β₂,σ₀)=nβ₂Lₙ(θ₀)+λ log n+ [symbol] (\sqrt{log n}) <Expression (37)>

In the simultaneous equations formed of Expressions (35), (36), and (37), by deleting the item of the real log canonical threshold λand the item of entropy Lₙ(θ₀), the following Expression (38) is obtained as a relational expression indicating a relation expressed by excluding the real log canonical threshold and the entropy.

$${F}_{n} ( 1 , {σ}_{0} ) = \frac{1 - {β}_{2}}{{β}_{1} - {β}_{2}} {F}_{n} ( {β}_{1} , {σ}_{0} ) - \frac{1 - {β}_{1}}{{β}_{1} - {β}_{2}} {F}_{n} ( {β}_{2} , {σ}_{0} ) \qquad < Expression ( 38 ) >$$

Accordingly, the correction unit 120 is able to calculate Fₙ(1,σ₀), which is the WBIC after the correction. This is because the value of Fₙ(β₁,σ₀) can be calculated as a value of Fₙ(1,σ₁) and the value of Fₙ(β₂,σ₀) can be calculated as a value of Fₙ(1,σ₂) (see Expression (28)). That is, Fₙ(β₁,σ₀) and Fₙ(β₂,σ₀) are two WBICs before correction calculated by the information criterion calculation unit 118. Specifically, one of the WBICs is a WBIC calculated by the kernel mean calculation unit 114 using σ₁ as σ in Expression (25) and the other one of the WBICs is a WBIC calculated by the kernel mean calculation unit 114 using σ₂ as σ in Expression (25). Therefore, the correction unit 120 generates the WBIC after the correction from the WBIC calculated by the information criterion calculation unit 118 by calculating Expression (38). In other words, it can also be said that Expression (38) describes processing in which the information criterion calculation unit 118 calculates the WBIC for each of two different contribution degrees (inverse temperatures) and the correction unit 120 calculates the weighted mean in accordance with the contribution degree (inverse temperature) regarding the WBIC calculated by the information criterion calculation unit 118.

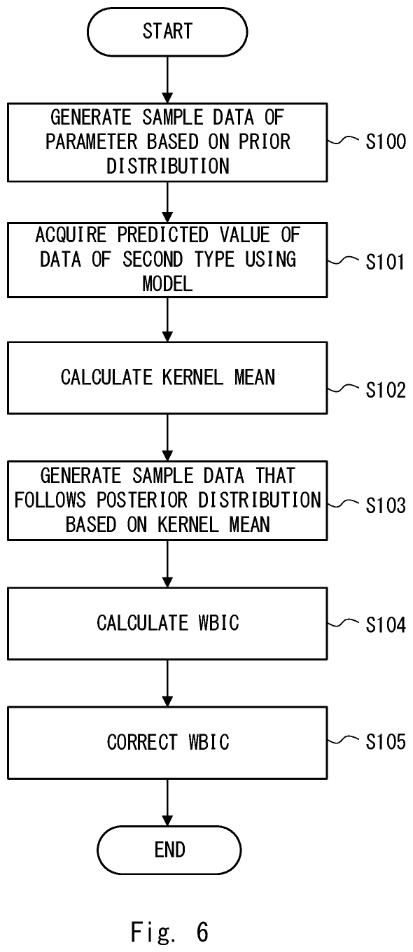

Next, an operation of the information criterion calculation apparatus 300 will be described with reference to a flowchart. FIG. 6 is a flowchart showing one example of the operation of the information criterion calculation apparatus 300. Hereinafter, the operation will be described with reference to FIG. 6. The flowchart shown in FIG. 6 is different from the flowchart shown in FIG. 4 in that Step S105 is added after Step S104. Hereinafter, the points of the flowchart shown in FIG. 6 different from the flowchart shown in FIG. 4 will be described.

In this example embodiment, after Step S104, the process moves to Step S105. In Step S105, the correction unit 120 corrects the WBIC before correction calculated in Step S104 in accordance with the first correction method or the second correction method described above.

However, when the correction is performed by the second correction method, two kinds of kernel means are calculated in Step S102. One of them is a kernel mean calculated by the kernel mean calculation unit 114 using σ₁ as σ in Expression (25) and the other one of them is a kernel mean calculated by the kernel mean calculation unit 114 using σ₂ as σ in Expression (25). Further, when the correction is performed by the second correction method, the sample data of the parameters is generated for each of the two kinds of kernel means in Step S103. Further, when the correction is performed by the second correction method, two WBICs are calculated in Step S104 using the two sets of sample data generated in Step S103.

The second example embodiment has been described above. In this example embodiment, the WBIC is corrected by the correction unit 120. It is therefore possible to obtain a more accurate value of the WBIC.

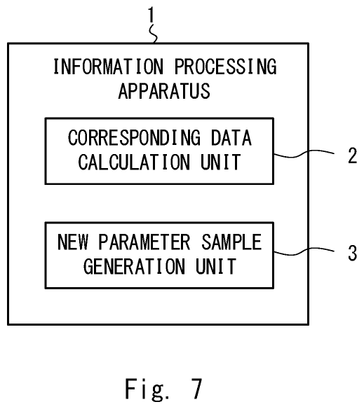

Note that the present disclosure is not limited to the above example embodiments and may be changed as appropriate without departing from the spirit of the present disclosure. For example, the following information processing apparatus 1 is also one example embodiment. FIG. 7 is a block diagram showing a configuration of the information processing apparatus 1. The information processing apparatus 1 includes a corresponding data calculation unit 2 and a new parameter sample generation unit 3.

The corresponding data calculation unit 2 determines the importance of the respective samples of the parameters based on the difference between the plurality of pieces of observation information (Yⁿ) observed when the input (Xⁿ) has been given to the observation target and the data of the second type (Y̅ⁿ), and the contribution degree (β) of each of the pieces of observation information in the above plurality of pieces of observation information. The data of the second type is data generated by the simulator that simulates the observation target based on the samples of the parameters with respect to the plurality of samples and the data of the first type indicating the input. Then the corresponding data calculation unit 2 calculates the data that corresponds to the distribution of the parameters.

The new parameter sample generation unit 3 generates new samples of the parameters in accordance with predetermined processing (e.g., Kernel Herding) using the data that corresponds to the distribution of the parameters calculated by the corresponding data calculation unit 2.

According to the above configuration, the information processing apparatus 1 is able to efficiently calculate parameters.

The whole or part of the exemplary embodiments disclosed above can be described as, but not limited to, the following supplementary notes.

### (Supplementary Note 1)

An information processing apparatus comprising:

corresponding data calculation means for determining importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information, and calculating data that corresponds to distribution of the parameters; and

new parameter sample generation means for generating a new sample of the parameters in accordance with predetermined processing using the data that corresponds to distribution of the parameters.

### (Supplementary Note 2)

The information processing apparatus according to Supplementary Note 1, further comprising information criterion calculation means for calculating a Widely Applicable Bayesian Information Criterion (WBIC) regarding a model in the simulator based on the sample of the parameters generated by the new parameter sample generation means.

### (Supplementary Note 3)

The information processing apparatus according to Supplementary Note 2, wherein a contribution degree of each of the pieces of observation information is constant or substantially constant.

### (Supplementary Note 4)

The information processing apparatus according to any one of Supplementary Notes 1 to 3, further comprising:

a priori parameter sample generation means for generating the plurality of samples that follow a prior distribution of the parameters; and

second type sample data acquisition means for acquiring the data of the second type that the simulator has generated based on the plurality of samples generated by the a priori parameter sample generation means.

### (Supplementary Note 5)

The information processing apparatus according to any one of Supplementary Notes 1 to 3, wherein

the data that corresponds to distribution of the parameters is a kernel mean,

the corresponding data calculation means calculates the kernel mean using a kernel function including the contribution degree as an inverse temperature, and

the new parameter sample generation means generates the sample using the kernel mean calculated by the corresponding data calculation means.

### (Supplementary Note 6)

The information processing apparatus according to Supplementary Note 5, wherein the corresponding data calculation means calculates the kernel mean by Kernel Approximate Bayesian Computation (Kernel ABC) that uses the kernel function indicated by the following expression,

where σ denotes a standard deviation of Gaussian noise regarding the data of the second type, n denotes the number of elements of the data of the second type, β denotes the inverse temperature, and Yᵢ and Yᵢ′ denote values of the data of the second type.

$$exp \{ - \frac{1}{2 {σ}^{2}} {\sum }_{i = 1}^{n} {β ( {Y}_{i} - {Y}_{i}^{′} )}^{2} \}$$

### (Supplementary Note 7)

The information processing apparatus according to Supplementary Note 2, further comprising correction means for correcting the WBIC calculated by the information criterion calculation means using a first relation, which is a relation between a WBIC in a case in which the value of the inverse temperature is set to 1 and the value of a standard deviation is set to a first standard deviation value in a first expression, which is an expression in which a expression of Bayes free energy is redefined so as to include an inverse temperature, and a WBIC in a case in which the value of the inverse temperature is set to a predetermined value other than 1 and the value of the standard deviation is set to a second standard deviation value in the first expression,

the model is modelled by a regression function that involves Gaussian noise,

the first standard deviation value is a value indicating the scale for measuring the similarity between the distribution of the observation information and the distribution of the data of the second type, and

the second standard deviation value is a value of standard deviation of the Gaussian noise with respect to the regression function.

### (Supplementary Note 8)

The information processing apparatus according to Supplementary Note 7, wherein the correction means corrects the WBIC calculated by the information criterion calculation means by using a second relation, which is a relation expressed by excluding a real log canonical threshold obtained from two expressions in which values of different inverse temperatures are set in a second expression, which is an expression obtained by performing asymptotic expansion on the first expression, and the first relation.

### (Supplementary Note 9)

The information processing apparatus according to Supplementary Note 7, wherein the correction means corrects the WBIC calculated by the information criterion calculation means by using a third relation, which is a relation expressed by excluding a real log canonical threshold and entropy obtained from three expressions in which values of different inverse temperatures are set in a second expression, which is an expression obtained by performing asymptotic expansion on the first expression, and the first relation.

### (Supplementary Note 10)

The information processing apparatus according to Supplementary Note 3, further comprising correction means for calculating likelihood regarding the new sample calculated by the new parameter sample generation means using the input and the observation information when the input has been given and correcting the WBIC based on the calculated likelihood.

### (Supplementary Note 11)

The information processing apparatus according to Supplementary Note 3, further comprising correction means for correcting the WBIC, wherein

the information criterion calculation means calculates the WBIC for each of two different contribution degrees, and

the correction means calculates a weighted mean that follows the contribution degree regarding the WBIC calculated by the information criterion calculation means.

### (Supplementary Note 12)

An information processing system comprising:

the information processing apparatus according to any one of Claims 1 to 11; and

the simulator,

wherein the simulator executes processing based on the sample generated by the new parameter sample generation means.

### (Supplementary Note 13)

An information processing method comprising:

determining, by an information processing apparatus, importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information and calculating data that corresponds to distribution of the parameters; and

generating, by the information processing apparatus, a new sample of the parameters in accordance with predetermined processing using the data that corresponds to distribution of the parameters.

### (Supplementary Note 14)

A non-transitory computer readable medium storing a program for causing a computer to execute:

a corresponding data calculation step for determining importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information and calculating data that corresponds to distribution of the parameters; and

a new parameter sample generation step for generating a new sample of the parameters in accordance with predetermined processing using the data that corresponds to distribution of the parameters.

While the present disclosure has been described above with reference to the example embodiments, the present disclosure is not limited to the above example embodiments. Various changes that may be understood by those skilled in the art within the scope of the present disclosure can be made to the configurations and the details of the present disclosure.

This application is based upon and claims the benefit of priority from Japanese Patent Application No. 2018-188190, filed on Oct. 3, 2018, the disclosure of which is incorporated herein in its entirety by reference.

### REFERENCE SIGNS LIST

1 Information Processing Apparatus
2 Corresponding Data Calculation Unit
3 New Parameter Sample Generation Unit
10 Information Processing System
100 Information Criterion Calculation Apparatus
101 Input/output Interface
102 Memory
103 Processor
110 First Parameter Sample Generation Unit
112 Second Type Sample Data Acquiring Unit
114 Kernel Mean Calculation Unit
116 Second Parameter Sample Generation Unit
118 Information Criterion Calculation Unit
120 Correction Unit
200 Simulator Server
300 Information Criterion Calculation Apparatus

1. An information processing apparatus comprising:
at least one memory storing instructions; and
at least one processor configured to execute the instructions stored in the memory to:
determine importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information, and calculate data that corresponds to distribution of the parameters; and
generate a new sample of the parameters in accordance with predetermined processing using the data that corresponds to distribution of the parameters.

2. The information processing apparatus according to claim 1, wherein the processor is further configured to execute the instructions to calculate a Widely Applicable Bayesian Information Criterion (WBIC) regarding a model in the simulator based on the generated sample of the parameters.

3. The information processing apparatus according to claim 2, wherein a contribution degree of each of the pieces of observation information is constant or substantially constant.

4. The information processing apparatus according to claim 1, wherein the processor is further configured to execute the instructions to:
generate the plurality of samples that follow a prior distribution of the parameters; and
acquire the data of the second type that the simulator has generated based on the generated plurality of samples.

5. The information processing apparatus according to claim 1, wherein
the data that corresponds to distribution of the parameters is a kernel mean, and
the processor is configured to execute the instructions to:
calculate the kernel mean using a kernel function including the contribution degree as an inverse temperature, and
generate the sample using the calculated kernel mean.

6. The information processing apparatus according to claim 5, wherein the processor is configured to execute the instructions to calculate the kernel mean by Kernel Approximate Bayesian Computation (Kernel ABC) that uses the kernel function indicated by the following expression,
where σ denotes a standard deviation of Gaussian noise regarding the data of the second type, n denotes the number of elements of the data of the second type, β denotes the inverse temperature, and Yᵢ and Yᵢ′ denote values of the data of the second type.
$$exp \{ - \frac{1}{2 {σ}^{2}} {\sum }_{i = 1}^{n} {β ( {Y}_{i} - {Y}_{i}^{′} )}^{2} \}$$

7. The information processing apparatus according to claim 2, wherein the processor is further configured to execute the instructions to correct the calculated WBIC using a first relation, which is a relation between a WBIC in a case in which the value of the inverse temperature is set to 1 and the value of a standard deviation is set to a first standard deviation value in a first expression, which is an expression in which a expression of Bayes free energy is redefined so as to include an inverse temperature, and a WBIC in a case in which the value of the inverse temperature is set to a predetermined value other than 1 and the value of the standard deviation is set to a second standard deviation value in the first expression,
the model is modelled by a regression function that involves Gaussian noise,
the first standard deviation value is a value indicating the scale for measuring the similarity between the distribution of the observation information and the distribution of the data of the second type, and
the second standard deviation value is a value of standard deviation of the Gaussian noise with respect to the regression function.

8. The information processing apparatus according to claim 7, wherein the processor is configured to execute the instructions to correct the calculated WBIC by using a second relation, which is a relation expressed by excluding a real log canonical threshold obtained from two expressions in which values of different inverse temperatures are set in a second expression, which is an expression obtained by performing asymptotic expansion on the first expression, and the first relation.

9. The information processing apparatus according to claim 7, wherein the processor is configured to execute the instructions to correct the calculated WBIC by using a third relation, which is a relation expressed by excluding a real log canonical threshold and entropy obtained from three expressions in which values of different inverse temperatures are set in a second expression, which is an expression obtained by performing asymptotic expansion on the first expression, and the first relation.

10. The information processing apparatus according to claim 3, wherein the processor is further configured to execute the instructions to:
calculate likelihood regarding the calculated new sample using the input and the observation information when the input has been given; and
correct the WBIC based on the calculated likelihood.

11. The information processing apparatus according to claim 3, wherein the processor is further configured to execute the instructions to:
calculate the WBIC for each of two different contribution degrees, and
correct the WBIC by calculating a weighted mean that follows the contribution degree regarding the calculated WBIC.

12. (canceled)

13. An information processing method comprising:
determining, by an information processing apparatus, importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information and calculating data that corresponds to distribution of the parameters; and
generating, by the information processing apparatus, a new sample of the parameters in accordance with predetermined processing using the data that corresponds to distribution of the parameters.

14. A non-transitory computer readable medium storing a program for causing a computer to execute:
a corresponding data calculation step for determining importance of each sample in accordance with a difference between a plurality of pieces of observation information observed when an input is given to an observation target and data of a second type generated by a simulator that simulates the observation target based on a sample of a parameter with respect to the plurality of samples and data of a first type indicating the input, and a contribution degree of each of the pieces of observation information in the plurality of pieces of observation information and calculating data that corresponds to distribution of the parameters; and
a new parameter sample generation step for generating a new sample of the parameters in accordance with predetermined processing using the data that corresponds to distribution of the parameters.
